(19) United States
(12) Patent Application Publication
(10) Pub. No.: US 2015/0056453 A1
(43) Pub. Date: Feb. 26, 2015

(54) ADHESIVE STRENGTH ENHANCEMENT OF SHAPE MEMORY POLYMER COMPOSITE AND METAL JOINT

(71) Applicant: U.S.A. represented by the Administrator of the National Aeronautics and Space Administration, Washington, DC (US)

(72) Inventors: Jin Ho Kang, Newport News, VA (US); Emilie J. SIOCHI, Newport News, VA (US); Ronald K. PENNER, Hampton, VA (US); Travis L. TURNER, Yorktown, VA (US)

(21) Appl. No.: 14/462,783

(22) Filed: Aug. 19, 2014

Related U.S. Application Data
(60) Provisional application No. 61/868,825, filed on Aug. 22, 2013.

(51) Int. Cl. B32B 15/08; B32B 37/14; B32B 38/00; B32B 37/00

(52) U.S. Cl. CPC B32B 15/08; B32B 37/0038; B32B 37/144; B32B 38/0012; B32B 2038/0016; B32B 2250/02; B32B 2605/18; B32B 2363/00; B32B 2379/08; B32B 2375/00
USPC 428/413; 156/309.3; 156/153; 428/457; 428/447; 428/423.3

(57) ABSTRACT

A composite article, including a metal alloy haying a first surface and a shape memory polymer (“SMP”) adjoining the first surface, with a coupling agent condensed on the first surface between the metal alloy and the SMP. The coupling agent includes at least one metal alloy bonding group which chemically bonds to the metal alloy member and at least one SMP bounding group which chemically bonds to the SMP member. A method for forming the article includes resurfacing a first surface of the metal alloy and applying a coupling agent to the first surface, and then positioning the SMP thereon. The article is then treated to condense the coupling agent on the first surface. A toughening agent is optionally added to the SMP prior to coupling the SW and the metal alloy.

### CROSS-REFERENCE TO RELATED PATENT APPLICATION(S)

This patent application claims the benefit of and priority to U.S. provisional patent application Ser. No. 61/868825, filed on Aug. 22, 2013, entitled “ADHESIVE STRENGTH ENHANCEMENT OF SHAPE MEMORY POLYMER COMPOSITE AND METAL JOINT,” the contents of which are hereby incorporated by reference in their entirety.

### STATEMENT REGARDING FEDERALLY SPONSORED RESEARCH OR DEVELOPMENT

The invention described herein was made in the performance of work under NASA contracts and by employees of the United States Government and is subject to the provisions of the National Aeronautics and Space Act, Public Law 111-31.4, §3 (124 Stat., 3330, 51 U.S.C. Chapter 201) and 35 U.S.C. §202, and may be manufactured and used by or for the Government for governmental purposes without the payment of any royalties thereon or therefore. In accordance with 35 U.S.C. §202, the contractor elected not to retain title.

### BACKGROUND OF THE INVENTION

Known methods of joining an SMP member and a metal alloy member may result in composite articles with relatively low adhesive strength between the SMP member and the metal alloy member. The adhesive strength may be insufficient to permit use of the composite articles as structural members in applications where delamination of the SMP member from the metal alloy could cause a failure of the structure in use.

### BRIEF SUMMARY OF THE INVENTION

The present disclosure relates to articles comprising a shape memory polymer (“SMP”) member joined to a metal alloy member and methods for joining a SMP member to a metal alloy member.

One embodiment of the invention is a composite article including a metal alloy member having a first surface and a shape memory polymer (“SMP”) member having a second surface. The second surface is secured to the first surface by a coupling agent. The coupling agent comprises a plurality of molecules with each molecule having at least one metal alloy bonding group that is chemically bonded to the first surface of the metal alloy member and at least one SMP bonding group that is chemically bonded to the second surface of the SMP member.

Another embodiment includes a method of coupling a metal alloy member and an SMP member including applying a coupling agent to at least one of a first surface of a metal alloy member and a second surface of the SMP member. The coupling agent comprises a plurality of molecules, each molecule including at least one metal. alloy bonding group and at least one SMP bonding group. The first surface and the second surface are brought into adjoining alignment with the coupling agent located therebetween. The coupling agent is condensed on the first surface. In some embodiments, the coupling agent is condensed on the first surface prior to bringing the first surface and the second surface into adjoining alignment. In other embodiments, the coupling agent is condensed after bringing the first surface and the second surface into alignment. Additionally, the first surface is optionally resurfaced prior to applying a coupling agent to the first surface. Further, the SMP member may optionally be formed in place on the first surface to bring the second surface into adjoining alignment with the first surface.

Yet another aspect of the invention includes a method of coupling a metal alloy member and a toughened SMP member. A first surface of the metal alloy member is resurfaced. The toughened SMP member is formed by incorporating a toughening agent into an SMP material, wherein the toughening agent includes at least one of nanotubes, nanoparticles, nanoplatelets, nanofibers, nanomultipods, polymers, or any combination thereof, which absorb fracture energy. A coupling agent is applied to the first surface of the metal alloy member. The coupling agent includes a plurality of molecules with each molecule having at least one metal alloy bonding group and at least one SMP bonding group. The first surface and the second surface are brought into adjoining alignment, with the coupling agent disposed therebetween. The coupling agent is condensed onto the first surface. As described above, in certain embodiments the coupling agent is condensed onto the first surface prior to bringing the first surface and the second surface into adjoining alignment.

The present disclosure allows an increased bonding strength between a metal alloy member and an SMP member, such that the resulting composite structures can be utilized in applications such as smart active structural materials for morphing spacecrafts, morphing airfoils for reduction of airframe noise, self-deployable space structures, morphing vehicles, smart armors for space/military applications and intelligent medical devices for the medical industry, and many other applications.

These and other features advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a side elevation schematic view of a composite article according to the present disclosure;

FIG. 2 is a flow chart illustrating one embodiment of a method of forming a composite article according to the present disclosure;

FIG. 3A is the chemical structure of one embodiment of a coupling agent according to the present disclosure; and

FIG. 3B is a flow chart illustrating the reaction of the coupling agent shown in FIG. 3A with a metal alloy.

### DETAILED DESCRIPTION OF THE INVENTION

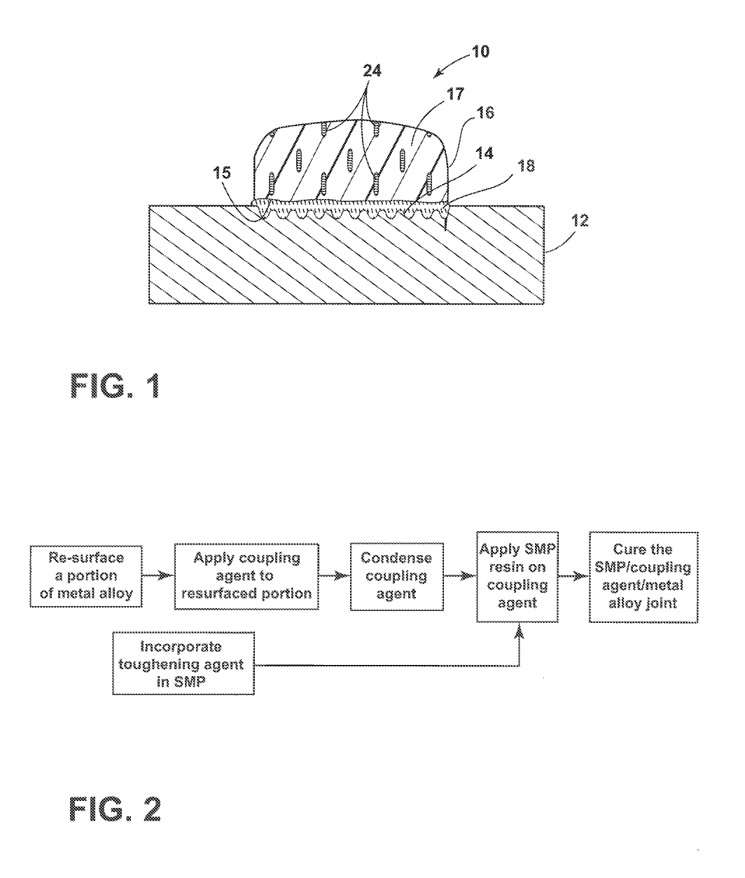

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Due to their unique shape memory capability, structures including an SMP member joined to a metal alloy member may be advantageous in applications requiring shape reconfiguration. These structures may be useful in adaptive wing structures in fixed wing aircrafts. These structures could also be used in smart active structural materials for morphing spacecrafts, morphing airfoils for reduction of airframe noise, self-deployable space structures, morphing vehicles, smart armors for space/military applications and intelligent medical devices for the medical industry. These types of applications may require interfacial adhesive strength between the SMP member and the metal alloy member to prevent delamination of the joint between the SMP member and the metal alloy member which could otherwise cause failure of these articles in use.

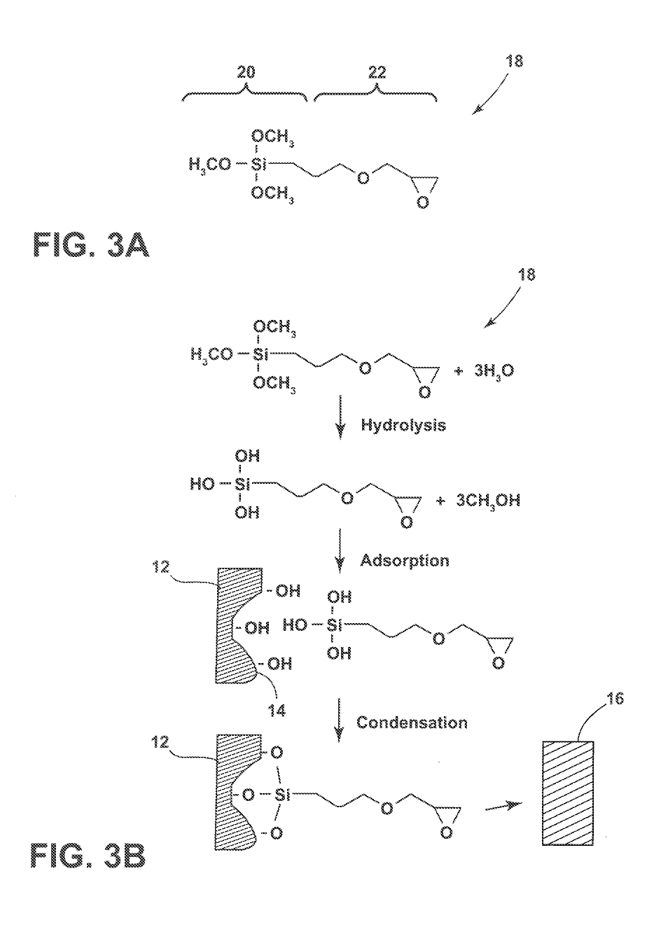

A composite article or structure according to the present disclosure is generally designated as reference numeral 10 in FIG. 1. The article 10 includes a metal alloy member 12 having a first surface 14 and a shape memory polymer (“SMP”) member 16 having a second surface 15 that is connected to the first surface 14 by a coupling agent 18. The coupling agent 18 is condensed on the first surface 14 of the metal alloy member 12. Specifically, as shown in the embodiment depicted in FIG. 3A, the coupling agent 18 includes at least one metal alloy bonding group 20 that forms a chemical bond with the metal alloy member 12 and at least one SMP bonding group 22 that forms a chemical bond with the SMP member 16. The unique characteristics of the disclosed composite articles 10 enable various applications for the articles 10 such as their use as smart fabrics, intelligent medical devices, self-deployable or morphing space structures, morphing airfoil structures, smart armors for space or military applications and packaging, and other uses.

As discussed in more detail below, in some embodiments, during fabrication of the article 10, the first surface 14 of the metal alloy member 12 is resurfaced, and a coupling agent is applied to the resurfaced first surface 14. The first surface 14 of the metal alloy member 12 with the coupling agent 18 thereon is brought into contact with the second surface 15 of the SMP member 16. The coupling agent 18 chemically bonds to the first surface 14 of the metal alloy member 12 and the coupling agent 18 also chemically bonds to the second surface 15 of the SMP member 16, to thereby interconnect the metal alloy member 12 and the SMP member 16. The SMP member 16 optionally comprises a structural member, or a portion of a structural component, formed utilizing known molding processes or other suitable processes.

The present disclosure is generally applicable to any metals, metal alloys, or composite materials including metal and other materials, all of which are referred to herein as “metal alloys.” More specifically, metal alloy members 12 can include titanium alloys or titanium-nickel alloys such as nitinol, which also have shape memory characteristics. The shape memory characteristics of such metal alloys can be chosen to be complementary to the characteristics of the SMP material to provide the desired characteristics for the finished article 10. The metal alloy member 12 optionally comprises a structural member, or portion of a structural component, formed utilizing known casting, forging, machining, or other suitable forming techniques.

The SMP member 16 comprises an SMP material 17. The SMP material 17 may comprise an epoxy-based SMP, a polyurethane based SMP, an imide based SMP, or any other SMP with suitable physical characteristics for the desired use of the article 10. Compared to metallic or ceramic shape memory materials, SMPs generally have superior intrinsically high elastic deformation, broad tailorability of mechanical properties, potential biocompatibility and biodegradability, ductility, light weight and ease of processing. The SMP member 16 optionally comprises a structural member, or a portion of a structural component, formed utilizing known molding processes or other suitable processes.

Toughening agents 24 can optionally be incorporated into the SMP material 17 to form the SMP member 16. The toughening agents 24 can be incorporated (e.g., mixed with the SMP material 17) at the time of forming the SMP member 16 to directly form a toughened SMP member 16. For example, the SMP member 16 may be molded utilizing known methods whereby the toughening agent 24 is mixed with the components of the SMP material 17 prior to molding the SMP material. Suitable toughening agents 24 include materials capable of absorbing fracture energy, and the toughening agents 24 therefore enhance the fracture toughness of the SMP material 17. Non-limiting examples of materials that can absorb fracture energy in the toughened SMP member 16 include at least one of an amphiphilic diblock or triblock copolymer, a core-shell dendrimer elastomeric polymer, or a nano-material chosen from the group of nanotubes, nanoparticles, nanoplates, nanofibers, nanosheets, and nanomultipods. The nanomaterials generally consist of one or more elements such as carbon, boron, oxygen, silicon, nitrogen, hydrogen, titanium, iron, cobalt, nickel, zinc, gallium, gold, aluminum, platinum, palladium, yttrium, tin, sulfur, bismuth, and tellurium. In embodiments, the toughening agent 24 is incorporated in an amount of about 0.01 wt % to about 20.0 wt % of the total weight of the toughened SMP member 16. In some embodiments, the wt % range for a given toughening agent 24 is sufficient to provide some absorption of fracture energy by increasing the cohesive strength of the SMP material 17. In an embodiment, the toughening agent 24 is an amphiphilic PBO-PEO diblock copolymer (“PBE”). In embodiments the concentration of PBE in the toughened SMP member 16 i about 0.01 wt % to about 20.0 wt % of the total weight of the toughened SMP member 16. In some embodiments, the toughening agent 24 includes carbon nanotubes (“CNT”) The concentration of CNT in the toughened SMP member 16 can be about 0.01 wt % to about 20.0 wt % of the total weight of the toughened SMP member 16. In some embodiments, the toughening agent 24 includes both PEE and CNT. In such an embodiment, the PBE is incorporated at about 5.0 wt % and the CNTs are incorporated at about 2.0 wt %.

The coupling agent 18 creates chemical bond promoted adhesion by preventing molecular slippage along the first surface 14 at the interface of the metal alloy member 12 and the SMP member 16 (which for purposes of this discussion includes any toughened SMP members 16, as well as SMP members 16 that do not include toughening agents 24) upon the application of force. Therefore, an increased fracture energy is required to overcome the interfacial attraction between the metal alloy member 12 and the SMP member 16. The coupling agent 18 includes at least one functional group at each end, with at least one metal alloy bonding group 20 at one end and at least one SMP bonding group 22 at the other end. As discussed in more detail below, the coupling agent 18 is condensed on the first surface 14 of the metal alloy member 12, with the metal alloy bonding groups 20 adjacent the metal alloy member 12, and the SMP bonding groups 22 extending away from the first surface 14 to interact with the SMP member 16. This allows the coupling agent 18 to chemically interact with both the metal alloy member 12 and the SMP member 16 to strengthen the bond therebetween.

In embodiments, the general formula of the coupling agent 18 is as follows:

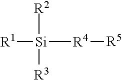

wherein R¹ has the formula CH₃(CH₂)ₐO where a=0, 1, or 2; R² has the formula CH₃(CH₂)_{b}O, where b=0, 1, or 2; and R³ has the formula CH₃(CH₂)_{c}O, where c=0, 1, or 2. R¹, R², and R³ can have the same formula as each other, or, in the alternative, one or more of R¹, R², and R³ can have differing formulas. R⁴ is an aromatic or aliphatic and has the formula (CH₂)_{d}, wherein d=0, 1, 2, 3, 4, or 5. R⁵ is a functional group selected from a glycidoxy group, an amino group, an isocyanate group, a hydroxyl group, and an anhydride group. In some embodiments, R⁵ can be one of the chemical structures shown below:

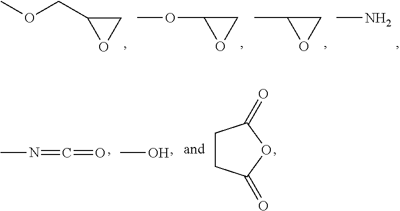

In some embodiments, the metal alloy is a titanium metal alloy and the metal alloy bonding group 20 is a silanol. Silanol groups can chemically bond to oxides or to bare metal surfaces, and are therefore useful as the metal alloy bonding group 20. In an embodiment, R⁵ constitutes the SMP bonding group 22, and R⁵ should be selected so that it corresponds with the type of SMP material that will be used such that the SMP bonding group is compatible with the selected SMP material. As non-limiting examples, when the SMP material is epoxy-based, R⁵ can be a glycidoxy group or an amino group; when the SMP material is polyurethane based, R⁵ can be an isocyanate group or a hydroxyl group; and when the SMP material is imide based, R⁵ can be an anhydride group. Two coupling agents 18 that can be used include (3-glycidyloxypropyl)trimethoxysilane (“OPTS”) and (3-aminopropyl)trimethoxysilane (“APTS”). GPTS includes a glycidoxy group as the SMP bonding group 22 and a silanol group as the metal alloy bonding group 20. APTS includes an amino group as the SMP bonding group 22 and a silanol group as the metal alloy bonding group 20.

In some embodiments, where the coupling agent 18 includes a silanol as the metal alloy bonding group 20, the coupling agent 18 is in an aqueous solution at a level of about 0.05 wt % to about 2.0 wt %. The effective concentration for each coupling agent 18 can be different, and can be determined by testing at various concentrations to determine the peak bonding strength. When using GPTS as the coupling agent 18, the concentration range can be about 0.05 wt % to about 0.5 wt % in an aqueous solution, and more specifically the concentration of OPTS can be about 0.1 wt % in an aqueous solution. When using APTS as the coupling agent 18, the concentration range can be about 0.1 wt % to about 1.0 wt % in an aqueous solution, and more specifically the concentration of APTS can be about 0.5 wt % in an aqueous solution.

As illustrated in the embodiment depicted in FIG. 2, in order to manufacture a composite article 10 as described herein, the first surface 14 of the metal alloy member 12 is resurfaced, and then the coupling agent 18 is applied to the first surface 14, then the coupling agent 18 is condensed to bond with the first surface 14 of the metal alloy member 12. The SMP resin 16 is applied on the first surface 14 having the coupling agent 18 thereon, and the SMP resin is then cured. The coupling agent 18 is chemically bonded to each of the metal alloy member 12 and the SMP member 16, strengthening the bond therebetween. In some embodiments, the toughening agent 24 is incorporated into the SMP member 16 to form a toughened SMP member 16, further strengthening the composite article 10 manufactured by this process.

To resurface the metal alloy, a weak boundary layer is removed from the first surface 14 of the metal alloy. The first surface 14 includes the area where the metal alloy member 12 will be bonded to the SMP member 16. In an embodiment, the weak boundary layer is removed from the first surface 14 by cleaning mechanically and then with an acid solution to create a fresh oxide layer. In one non-limiting example, the first surface 14 of the metal alloy is mechanically cleaned by grit blasting with particles having a 100-170 mesh particle size at 70-75 psi. A Trine Dry Blast Model 36/PP, by the Trinity Tool Company used with Flesx-O-Lite grade particles is capable of executing this mechanical cleaning. This mechanical cleaning results in additional surface roughness of the first surface 14. Also, in an embodiment, after the mechanical cleaning, an aqueous acid solution of hydrofluoric acid and nitric acid is applied to the first surface 14 to chemically clean the first surface 14. The volumetric ratio of HF:HNO₃H₂O can be about 5:45:50. The aqueous acid solution is left in contact with the first surface 14 for about 5 minutes, and is then rinsed with water and isopropanol to remove the aqueous acid solution and drive any remaining water off of the first surface 14. This mechanical and chemical cleaning results in a fresh oxide layer on the first surface 14 with a desired texture, where the fresh oxide layer has enhanced wetting characteristics with respect to an untreated surface of the metal alloy. The mechanical and chemical cleaning steps described herein can be carried out one hour or less before the next step in the process, while the newly formed oxide layer on the first surface 14 remains thin and fresh. Additionally, the mechanical and chemical cleaning steps can be adjusted to obtain the desired surface topography of the first surface 14, e.g., grit blasting until a desired surface topography is achieved.

Producing thin, fresh oxides eliminates a weak boundary layer on the first surface 14, and provides better wettability of the SMP resin on the first surface 14 of the metal alloy member 12 by increasing the spreading coefficient, S, expressed as:

S=λₛᵥ−λₛₗλₗᵥ,

where S is the spreading coefficient, λₛᵥ is the solid-vapor interfacial free energy, λₛₗ is the solid-liquid interfacial free energy, and λlv is the liquid vapor interfacial free energy.

In one non-limiting example, the interfacial energies of the first surface 14 of a titanium metal alloy before mechanical and chemical cleaning steps for λₛᵥ, λₛₗ and λₗᵥ are 52.0 mN/m, 33.6 mN/m, and 44.9 mN/m, respectively, as measured by a dynamic wettability tester. The spreading coefficient, S_{before} was about −16.5 mN/m, which indicates that the first surface 14 had poor wettability prior to the mechanical and chemical cleaning. After the mechanical and chemical cleaning, the formation of fresh oxides increased the λₛᵥ (100.3 mN/m) to a greater extent than changes to the other term (λₛₗ: 65.6 mN/m), and the spreading coefficient, S_{after} (−10.2 mN/m) increased for better wetting of the SMP on the titanium alloy surface. After the mechanical and chemical cleaning as described herein, lap-shear specimens of titanium metal alloy members 12 and an epoxy-based SMP member 16 were prepared and tested for shear strength according to ASTM D5868-01. In the testing sample, the epoxy-based SMP was applied between two titanium-alloy coupons to produce lap shear specimens. The lap-shear specimens were clamped under pressure of about 30 kPa and cured in a convection oven at 125° C. for 4 hours, 150° C. for 4 hours and 175° C. for 2 hours. The adhesive strength between the SMP and the titanium alloy after mechanical cleaning and chemical cleaning was about 17.1 MPa, which is greater than when the lap shear testing is performed without mechanical and chemical cleaning of the first surface 14.

The coupling agent 18, as described above, can be applied on the first surface 14 of the metal alloy after resurfacing of the metal alloy, such that the coupling agent 18 is disposed between the resurfaced first surface 14 of the metal alloy member 12 and the SMP member 16. The coupling agent 18 is then condensed on the first surface 14 of the metal alloy, by treating at an elevated temperature for a period of time. To condense the coupling agent 18 on the first surface 14, the metal alloy member 12 with the coupling agent 18 is treated at an elevated temperature, between about 100° C. and about120 ° C. for a time period sufficient to allow the coupling agent 18 to condense. Generally, a time period of thirty minutes or greater is sufficient to allow coupling agents 18 with silanol groups to condense with hydroxyl groups on the first surface 14 of the metal alloy member 12.

As shown in FIGS. 3A-3B, condensation of one embodiment of the coupling agent 18 to the first surface 14 involves several steps. At the elevated temperatures, the coupling agent 18 undergoes hydrolysis, adsorption onto the surface of the metal alloy member 12, and condensation to more strongly adhere to the surface of the metal alloy member 12. The other reactive group on the coupling agent 18, the SMP bonding group 22, is reacted with the SMP member 16 to bond the SMP member 16 with the metal alloy member 12.

In FIG. 3B, the reaction of the coupling agent 18, GPTS, with the surface of a metal alloy member 12 is illustrated. The condensation reaction shown in FIG. 3B is carried out by contacting an aqueous solution of the GPTS coupling agent 18 with the first surface 14 of the metal alloy member 12, and holding the first surface 14 and aqueous solution at an elevated temperature for a period of time. The SMP member 16 is optionally strengthened by incorporating the toughening agent 24 therein to toughen the SMP member 16. To incorporate the toughening agent 24 into the SMP, the toughening agent 24 is added to the SMP material 17 at the time of its formation, and is distributed throughout the SMP member 16 to toughen the SMP member 16. The toughening agents 24 absorb fracture energy, and thereby increase the cohesive strength of the SMP member 16. The increased toughness is believed to be due to the micro-phase separation toughening mechanism by which energy can be efficiently dissipated upon the addition of certain polymers such as PBE. When other toughening agents 24 are used, such as CNTs, the increased toughness may be due to debonding and pullout of CNTs from the matrix of the SMP material 17.

It is also important to note that the construction and arrangement of the elements of the device as shown in the exemplary embodiments is illustrative only. Although only a few embodiments of the present innovations have been described in detail in this disclosure, those skilled in the art will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may he constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may he constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may he combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” As used herein, the term “and/or” includes any and all combinations of one or more of the associated listed items. As also used herein, the term “combinations thereof” includes combinations having at least one of the associated listed items, wherein the combination can further include additional, like non-listed items. Further, the terms “first,” “second,” and the like herein do not denote any order, quantity, or importance, but rather are used. to distinguish one element from another. The modifier “about” used in connection with a quantity is inclusive of the stated value and has the meaning dictated by the context (e.g., it includes the degree of error associated with measurement of the particular quantity).

Reference throughout the specification to “another embodiment”, “an embodiment”, “exemplary embodiments”, and so forth, means that a particular element (e.g., feature, structure, and/or characteristic) described in connection with the embodiment is included in at least one embodiment described herein, and can or cannot be present in other embodiments. In addition, it is to he understood that the described elements can be combined in any suitable manner in the various embodiments and are not limited to the specific combination in which they are discussed.

What is claimed is:

1. A composite article, comprising:
a metal alloy member having a first surface; and
a shape memory polymer (“SMP”) member having a second surface secured to the first surface by a coupling agent, wherein the coupling agent comprises a plurality of molecules with each molecule having at least one metal alloy bonding group that is chemically bonded to the first surface of the metal alloy member and at least one SMP bonding group that is chemically bonded to the second surface of the SMP member.

2. The composite article of claim 1, wherein:
the metal alloy member comprises a titanium alloy; and
the metal alloy bonding group comprises a silanol.

3. The composite article of claim 1, wherein:
the SMP member comprises an epoxy-based SMP material; and
the SMP bonding group is a glycidoxy group or an amino group.

4. The composite article of claim 1, wherein:
the SMP member comprises a polyurethane based SMP material; and
the SMP bonding group is an isocyanate group or a hydroxyl group.

5. The composite article of claim 1, wherein:
the SMP member comprises an imide based SMP material; and
the SMP bonding group is an anhydride group.

6. The composite article of claim 1, further comprising:
a toughening agent incorporated into the SMP material, wherein the toughening agent includes at least one of nanotubes, nanoparticles, nanoplatelets, nanofibers, nanomultipods, polymers, or a combination thereof, which absorb fracture energy.

7. The composite article of claim 1 wherein:
the metal alloy member comprises a titanium metal alloy;
the SMP member comprises an epoxy-based SMP material; and
the coupling agent is chosen from 3-glycidyloxypropyl)trimethoxysilane (“GPTS”) and 3-aminopropyl)trimethoxysilane (“APTS”).

8. The composite article of claim 1, wherein:
the article is at least a portion of an adaptive wing structure for a fixed wing aircraft.

9. A method of coupling a metal alloy member and a Shape memory polymer (“SMP”) member, comprising:
applying a coupling agent to at least one of a first surface of a metal alloy member and a second surface of an SMP member, wherein the coupling agent comprises a plurality of molecules, each molecule including at least one metal alloy bonding group and at least one SMP bonding group;
bringing the first surface and the second surface into adjoining alignment, with the coupling agent disposed therebetween; and
condensing the coupling agent on the first surface.

10. The method of claim 9, further comprising:
resurfacing the first surface of the metal alloy member.

11. The method of claim 10, wherein the step of resurfacing the first surface of the metal alloy member includes:
mechanically roughening the first surface; and
chemically resurfacing the first surface using an acidic solution, wherein the mechanical roughening and chemical resurfacing reveal a fresh oxide layer on the first surface of the metal alloy.

12. The method of claim 9, wherein:
the coupling agent is applied to the first surface of the metal alloy.

13. The method of claim 9, wherein:
the coupling agent is condensed on the first surface prior to bringing the first surface and the second surface into adjoining alignment with the coupling agent disposed therebetween.

14. The method of claim 9, wherein the coupling agent has the general formula 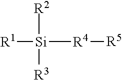
wherein R¹ has the formula CH₃(CH₂)ₐO, where a=0, 1, or 2;
wherein R² has the formula CH₃(CH₂)_{b}O, where b=0, 1, or 2;
wherein R³ has the formula CH₃(CH₂)_{c}O, where c=0, 1, or 2, and wherein R¹, R², and R³ can have the same formula or can have formulas that are different from each other;
wherein R⁴ is aromatic or aliphatic and has the formula (CH₂)_{d}, wherein d=0, 1, 2, 3, 4, or 5; and
wherein R⁵ is chosen from a glycidoxy group, an amino group, an isocyanate group, a hydroxyl group, and an anhydride group.

15. The method of claim 14, wherein:
the coupling agent is chosen from 3-glycidyloxypropyl)trimethoxysilane (“GPTS”) and (3-aminopropyl)trimethoxysilane (“APTS”) and wherein the SMP member is an epoxy-based SMP material.

16. The method of claim 9, wherein:
condensing the coupling agent includes treating the assembled metal alloy member having the coupling agent disposed therebetween at a temperature of between about 100° C. and about 120° C. for a time period of about 30 minutes or greater.

17. A method of coupling a metal alloy member and a toughened shape memory polymer (“SMP”) member, comprising:
resurfacing a first surface of the metal alloy member;
forming the toughened SMP member by incorporating a toughening agent into an SMP material, wherein the toughening agent includes at least one of nanotubes, nanoparticles, nanoplatelets, nanofibers nanomultipods, polymers, or any combination thereof, which absorb fracture energy
applying a coupling agent on at least one of the first surface of the metal alloy member and a second surface of the toughened SMP member, wherein the coupling agent comprises plurality of molecules with each molecule having at least one metal alloy bonding group and at least one SMP bonding group;
bringing the first surface and the second surface into adjoining alignment, with the coupling agent disposed therebetween; and
condensing the coupling agent on the first surface.

18. The method of claim 17, wherein:
the coupling agent is condensed on the first surface prior to bringing the first surface and the second surface into adjoining alignment with the coupling agent disposed therebetween.

19. The method of claim 17, wherein incorporating the toughening agent into the SMP material includes incorporating at least an amphiphilic PBO-PEO diblock copolymer (“PBE”) and carbon nanotubes (“CNT”) into the SMP member.

20. The method of claim 17, wherein the toughening agent includes at least one of an amphiphilic diblock or triblock copolymer, a core-shell dendrimer an elastomeric polymer, or a nano-material chosen from the group consisting of nanotubes, nanoparticles, nanoplates, nanofibers, nanosheets, nanomultipods, wherein the nano-material consists of carbon, boron, oxygen, silicon, nitrogen, hydrogen, titanium, iron, cobalt, nickel, zinc, gallium, gold, aluminum, platinum, palladium, yttrium, tin, sulfur, bismuth, tellurium, or any combination thereof.
